(19) United States
(12) Patent Application Publication
(10) Pub. No.: US 2007/0158403 A1
(43) Pub. Date: Jul. 12, 2007

(54) Business card information exchange device and method

(76) Inventor: Hasan Ertas, San Jose, CA (US)

Correspondence Address: Hasan Ertas, 5256 Makati Circle, San Jose, CA, 95123, US

(21) Appl. No.: 11/329,816

(22) Filed: Jan. 10, 2006

(51) Int. Cl. G06F 17/00

(52) U.S. Cl. 235/375

(57) ABSTRACT

A standalone business card information exchange device and associated method are disclosed. The device includes a processor and a card reader coupled to the processor, the card reader operable to read business card information associated with each user. A storage medium coupled to the processor stores read business card information associated with each user and a camera coupled to the processor captures an image associated with the read business card information associated with each user. An audio/video device may be coupled to the processor for storing an audio/video clip associated with each user. A means for allowing modification of the read business card information associated with each user by the user and a means for distributing the stored business card information to the plurality of users are also provided.

### FIELD OF THE INVENTION

The present invention relates generally to the distribution of business card information and more particularly to a standalone business card information exchange device and method of use.

### BACKGROUND OF THE INVENTION

In typical networking events such as social gatherings, business meetings and business conferences, attendees generally intend to meet as many people and make as many contacts as possible in order to broaden their network. As part of this effort an attendee may meet and greet other attendees and exchange business cards. In large gatherings, meetings and conferences, an attendee may not be able to meet and greet all of the attendees and consequently social and business opportunities may be missed.

There are many prior art apparatus, methods and systems that attempt to manage information such as business card information but none address the above-identified problem. For example, U.S. Pat. No. 6,254,001 entitled “Electronic Business Card Device” discloses a method of transferring business card information from a first user to a second user. The method includes the steps of providing the first and second users with an electronic business card device, storing data similar to that stored on a business card in a memory in each of the electronic business cards, selectively displaying at least some of the stored business card data on a visual display screen, and selectively transferring the stored business card data of at least the first user to the electronic business card of the other user for storage and selective retrieval. The disclosed method disadvantageously requires a plurality of electronic business card devices.

Another apparatus is disclosed in U.S. Pat. No. 6,412,689 entitled “Communication Equipment and Method for Business Card Information Interchange”. Communication equipment automatically interchanges business card information and displays such information on a display, thus making operation by a user for interchanging business card information unnecessary. The communication equipment includes a business card memory, a business card information display, a business card information reception function, a business card information transmission function, a communication equipment detection function, a network transmission/reception function, a storage device, a display and a mouse. When the communication equipment function detection function finds communicable equipment, the communication equipment displays a list of the communicable equipment. The user then starts communication with the desired counterpart. The business card information is automatically interchanged allowing direct input of the business card information to the equipment. The disclosed equipment and method requires dedicated equipment such as PDAs.

Other prior art apparatus, methods and systems directed to managing business card information include U.S. Pat. No. 6,374,259 entitled “Method and Apparatus for Storing and Retrieving Business Contact Information in Computer System”. Business card information is stored in an internet-accessible database of a computer system. U.S. Pat. No. 6,533,171 entitled “Electronic Business Card Exchange” discloses the use of smart cards. U.S. Patent Application Publication No. 2004/0236792 entitled “Method and Apparatus for Storing and Retrieving Business Contact Information in a Computer System” discloses an information management system comprising a remote device, a remote database operatively coupled to the remote device, the remote database containing contact information for each of a plurality of users of the information management system, wherein each of the users is assigned a unique user identifier, and the information for each user is stored along with the unique user identifier of the user in the remote database, wherein the remote device includes a wireless network interface module that interfaces with a wireless network to allow users of the information management system to access the remote device.

The prior art apparatus, methods and systems do not provide for a simple, inexpensive and real-time solution to the problem of sharing business card information at social gatherings, business gatherings and conferences, and educational classrooms. Rather, prior art solutions rely on dedicated apparatus such as electronic business card devices and PDAs or business card information databases requiring time-intensive data entry and data processing.

There is therefore a need in the art for a business card information exchange device and method that overcomes the disadvantages of the prior art. What is needed is a business card information exchange device and method that provides business card information to each of a plurality of event attendees without significant time delays. What is also needed is a business card information exchange device and method that is practical and that does not require that users own devices such as PDAs and cell phones. What is also needed is a business card information exchange device and method that is less costly than existing systems and methods. Moreover, what is needed is a business card information exchange device and method that distributes business card information by e-mail. In addition, what is needed is a business card information exchange device and method that prints business card information. What is also needed is a business card information exchange device and method that distributes business card information in a wired and a wireless manner.

### SUMMARY OF THE INVENTION

The present invention overcomes the disadvantages of the prior art by providing a standalone business card information exchange device operable to read a plurality of business cards and to distribute the read business card information in any one of a plurality of formats including an e-mail message, a printout, a specific file format, a wireless transmission, and a wired transmission. An application running on the business card information exchange device allows users to edit and update their business card information before the information is distributed.

In accordance with another aspect of the invention, a standalone business card information exchange device operable to read and distribute business card information of a plurality of users includes a processor, a card reader operable to read the business card information associated with each user coupled to the processor, a storage medium coupled to the processor for storing read business card information associated with each user, and a means for allowing user modification of the read business card information of that user coupled to the processor. The stored business card information associated with the plurality of users is distributed to a plurality of users to enable the timely exchange of such information.

In accordance with yet another aspect of the invention, a method of exchanging user's business card information includes the steps of (a) reading a user's business card information into a computing device, (b) allowing the user to edit the read information, (c) associating an image of the user with the edited information, (d) storing the edited information and the associated image in a database in the computing device, (e) repeating steps (a) through (d) for each additional user, and (f) providing user access to the database.

There has been outlined, rather broadly, the more important features of the invention in order that the detailed description thereof that follows may be better understood, and in order that the present contribution to the art may be better appreciated. There are, of course, additional features of the invention that will be described below and which will form the subject matter of the claims appended herein.

In this respect, before explaining at least one exemplary embodiment of the invention in detail, it is to be understood that the invention is not limited in its application to the details of design, component parts, and to the sequence of steps and processes set forth in the following description or illustrated in the drawings. The invention is capable of other embodiments and of being practiced and carried out in various ways. Also, it is to be understood that the phraseology and terminology employed herein, as well as the abstract, are for the purpose of description and should not be regarded as limiting.

### BRIEF DESCRIPTION OF THE DRAWINGS

The present disclosure may be better understood and its numerous features and advantages made apparent to those skilled in the art by referencing the accompanying drawings.

FIG. 1 is a schematic representation of the business card information exchange device in accordance with the invention;

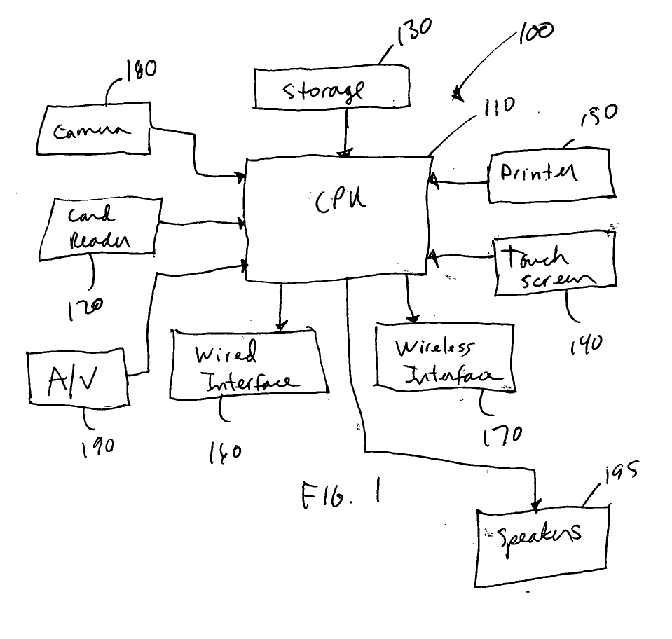

FIG. 2 is a flow diagram of a method in accordance with the invention; and

FIG. 3 is a representative housing configuration of the business card information exchange device in accordance with the invention.

### DETAILED DESCRIPTION OF THE INVENTION

Specific details are given in the following detailed description to provide a thorough understanding of the embodiments. However, it will be understood by one of ordinary skill in the art that the embodiments maybe practiced without these specific details. For example, circuits may be shown in block diagrams in order not to obscure the embodiments in unnecessary detail. In other instances, well-known circuits, structures and techniques may be shown without unnecessary detail in order to avoid obscuring the embodiments.

As such, those skilled in the art will appreciate that the conception upon which this disclosure is based may readily be utilized as a basis for the designing of other methods and systems for carrying out the several purposes of the present invention. It is important, therefore, that the claims be regarded as including such equivalent methods and systems insofar as they do not depart from the spirit and scope of the present invention.

Also, it is noted that the embodiments may be described as a process which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be rearranged. A process is terminated when its operations are completed, but could have additional steps not included in the figure. A process may correspond to a method, a function, a procedure, a subroutine, a subprogram, etc. When a process corresponds to a function, its termination corresponds to a return of the function to the calling function or the main function.

Moreover, as disclosed herein, the term “computer-readable medium” includes, but is not limited to portable or fixed storage devices, optical storage devices, wireless channels and various other mediums capable of storing, containing or carrying instruction(s) and/or data.

Furthermore, embodiments may be implemented in hardware, software, firmware, middleware, microcode, hardware description languages, or any combination thereof. When implemented in software, firmware, middleware or microcode, the program code or code segments to perform the necessary tasks may be stored in a machine readable medium such as storage medium. One or more processors may perform the necessary tasks. A code segment may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, and data may be passed, forwarded, or transmitted via any suitable means including memory sharing, message passing, token passing, and network transmission.

In an exemplary embodiment of the invention, a standalone business card information exchange device generally designated 100 may include a card reader 120 coupled to a processor 110 operable to execute the method of the invention. Processor 110 may include a processor of a computing device such as a tablet PC, a laptop computer, a handheld organizer, and a PDA. Card reader 120 may include a conventional business card reader having image and character recognition functionality for recognizing a plurality of fields including a graphical format image, a user's name, company name, address and phone numbers. Card reader 120 may be coupled to the processor 110 in either a wired or wireless manner or the card reader can be a built-in part of the processor 110. The read business card information, including images and characters associated with each user, may be stored in a storage medium 130 coupled to the processor 110 in a conventional manner.

The business card information exchange device 100 further includes a touch screen 140 which may be a tablet PC touch screen. Upon insertion of a business card (not shown) in the card reader 120, the business card information may be displayed on the touch screen 140 and edited by an attendee before being stored in the storage medium 130. For example, the attendee's name may be “Smith” but the character recognition software may incorrectly recognize “Smith” as “Smitk”. The attendee may be prompted to edit field information at which point the attendee may correct the erroneous field. Alternatively, the attendee may want to update fields having outdated information with current information. The attendee may also add information not read by the card reader 120 such as the nature of the company's business or other personal information that is not conventionally displayed on standard business card such as personal email addresses or websites. The attended may be prompted by the business card information exchange device 100 by means of audio instructions broadcast from speakers 195 coupled to processor 110.

Once all of the attendees desiring to exchange business card information have had the business card information read by the card reader 120, edited the information, and had the information stored in the storage medium 130, the processor 110 may be operable to provide all of the business card information stored to the participating attendees. For this purpose a printer 150 may be coupled to the processor 110 for printing a printout of the business card information. Alternatively, the business card information may be distributed by wired interface 160 and by wireless interface 170.

A camera 180 may be coupled to the processor 110. Camera 180 may be a conventional digital camera. Attendees may optionally choose to have their pictures taken for inclusion of an image with the business card information read by the card reader 120 and associated with each user. The inclusion of an image of the attendee with the associated business card information may help the other attendees more easily remember the attendee. In addition an audio/video device 190 may be coupled to the processor 110 and be operable to record a short video and audio message or clip which may be associated with the business card information of the associated user. The audio/video clip may include a discussion of the experience of the associated user.

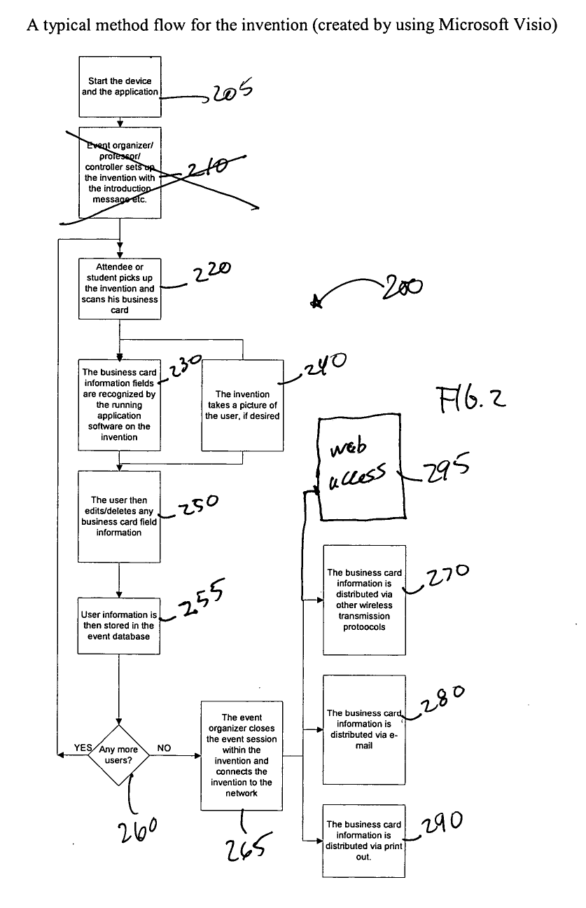

With reference to FIG. 2, a method for exchanging business card information generally designated 200 may include a step 205 in which the business card information exchange device 100 may be initialized. A graphical user interface may be displayed on the touch screen 140 for use in prompting the user. Audio prompts may also be provided. In a step 220 the user may use the card reader 140 to input business card information and in a step 230 the application running on the processor 110 may display the information associated with the user on the touch screen 140. If desired, an image and audio/video clip of the attendee may be saved together with the business card information associated with the user in a step 240.

In a step 250 the user may edit the business card information associated with him and displayed on the touch screen 140 and in a step 255 the edited information may be stored in storage 130. In a step 260, a decision may be made whether more users will enter their business card information. If more users will enter their business card information, the method returns to step 220, otherwise in a step 265 the business card information of the users having entered their business card information is compiled by the processor 110 and formatted for distribution. In a step 270 the compiled business card information may be distributed by wireless transmission. In a step 280 the compiled information may be e-mailed to the attendees. In a step 290 the compiled information may be printed by printer 150. In a step 295 the compiled information may be accessed from a web resource.

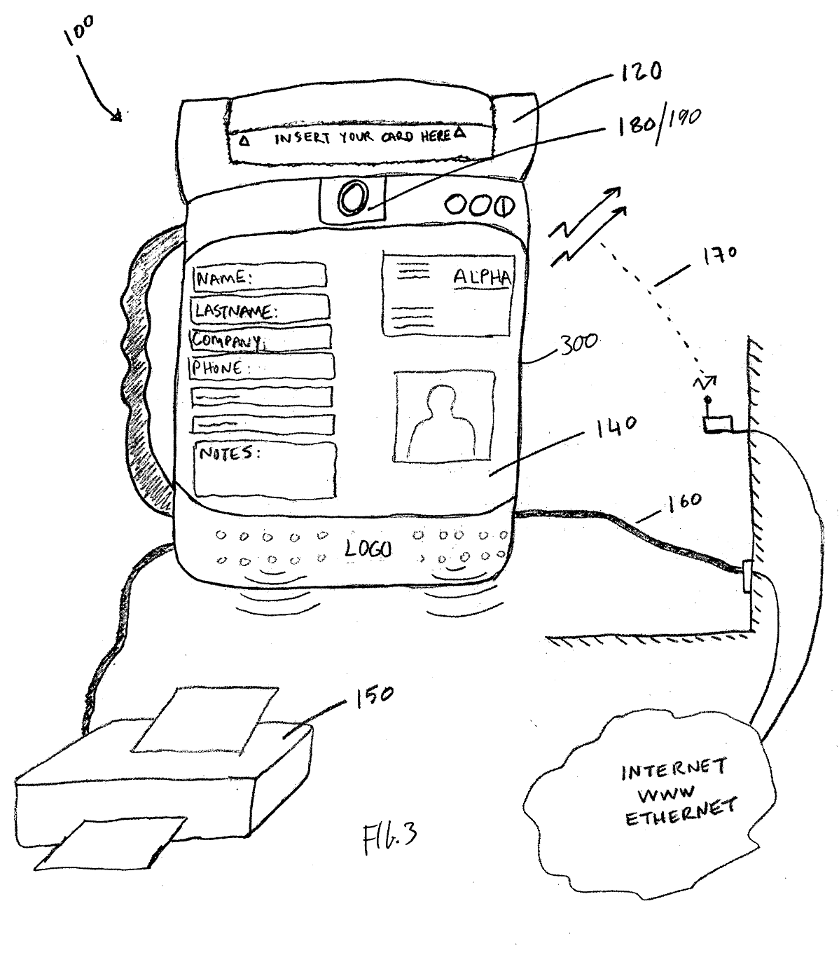

In a preferred embodiment of the invention and as shown in FIG. 3, the standalone business card information exchange device 100 may include a tablet PC 300 having the card reader 120 and the camera 180 and audio/video device 190 connected mechanically one to the other. This embodiment provides for easy transport of the standalone business card information exchange device 100.

The standalone business card information exchange method and device of the invention provide for the easy and convenient exchange of business card information in a timely manner. By providing for an image and audio/video clip of the user together with the business card information of that user, the device and method facilitate recognition and use of the business card information distributed to the attendees of a networking function. The device and method further provide a means by which attendees can easily edit their business card information including adding additional information.

The foregoing description of the embodiments of the invention has been presented for the purposes of illustration and description. It is not intended to be exhaustive or to limit the invention to the precise form disclosed. Many modifications and variations are possible in light of the above teaching. It is intended that the scope of the invention be limited not by this detailed description, but rather by the claims appended hereto.

We claim:

1. A business card information exchange device operable to read and distribute business card information of a plurality of users comprising:
a processor;
a card reader coupled to the processor, the card reader operable to read business card information associated with each user;
a storage medium coupled to the processor for storing read business card information associated with each user;
a means coupled to the processor for allowing modification of the read business card information associated with each user by the user; and
a means coupled to the processor for distributing the stored business card information to the plurality of users.

2. The device of claim 1, wherein the means for allowing modification of the read business card information comprises a touch screen coupled to the processor, the touch screen having a graphical user interface for accepting the user's modifications.

3. The device of claim 1, wherein the card reader is operable to read business card fields using character recognition of graphical format images.

4. The device of claim 3, wherein the business card fields are editable by the user.

5. The device of claim 1, further comprising a means for allowing user input of information in addition to the read business card information.

6. The device of claim 5, wherein the means for allowing user input of information comprises a touch screen coupled to the processor, the touch screen having a graphical user interface.

7. The device of claim 1, further comprising a printer coupled to the processor and a camera coupled to the processor for capturing an image associated with the read business card information associated with each user.

8. The device of claim 1, wherein the processor and storage medium comprise a tablet PC and the means for allowing user modification of the read business card information comprise a tablet PC touch screen having a graphical user interface.

9. The device of claim 8, wherein the card reader and a camera are mechanically coupled to the tablet PC.

10. The device of claim 1, wherein the read business card information is stored in a database.

11. The device of claim 10, wherein the database is accessible by means of a web resource.

12. The device of claim 10, wherein the database is accessible by means of a wireless interface coupled to the processor.

13. The device of claim 10, wherein the database is accessible by means of a wired interface coupled to the processor

14. A method of exchanging business card information of a plurality of users comprising the steps of:
(a) reading a user's business card information into a computing device;
(b) allowing the user to edit the read information;
(c) associating an image of the user with the edited information;
(d) storing the edited information and the associated image in a database in the computing device;
(e) repeating steps (a) through (d) for each additional user; and
(f) providing user access to the database.

15. The method of claim 14, wherein providing user access comprises printing the business card information and associated images.

16. The method of claim 14, wherein providing user access comprises providing wireless and wired access to the business card information and associated images.

17. The method of claim 14, wherein the read information comprises text and images.

18. The method of claim 14, wherein providing user access comprises providing access to the business card information from a web resource.

19. The method of claim 14, wherein allowing the user to edit the read information comprises allowing changes to the read information.

20. The method of claim 14, wherein allowing the user to edit the read information comprises allowing additions to the read information.
